(19) United States
(12) Patent Application Publication
(10) Pub. No.: US 2015/0207257 A1
(43) Pub. Date: Jul. 23, 2015

(54) ELECTRICAL CONNECTOR HAVING INSULATIVE MEMBERS AND METHOD OF MAKING THE SAME

(71) Applicant: FOXCONN INTERCONNECT TECHNOLOGY LIMITED, Grand Cayman (KY)

(72) Inventors: HAI-QIONG DAI, Xinyang (CN); JING-JIE GUO, Huaian (CN)

(21) Appl. No.: 14/603,327

(22) Filed: Jan. 22, 2015

(30) Foreign Application Priority Data
Jan. 22, 2014 (CN) 201410028618.9

(51) Int. Cl. H01R 13/405

(52) U.S. Cl. CPC H01R 13/405

(57) ABSTRACT

A electrical connector (100) includes an insulative housing (1), a number of terminals (2), a stiffener (3) and a pair of insulative members (4). The insulative housing includes a tongue portion (11) defining a number of first passageways (111a) and two molding holes (115a, 115b) communicating with the first passageways for accommodating a number of molds. The stiffener is insert molded with the insulative housing and defines two openings (33a, 33b) communicating with the molding holes. The insulative members cover the openings for sealing the molding holes after removal of the molds.

### BACKGROUND OF THE INVENTION

1. Field of the Invention

The present invention relates to an electrical connector, and more particularly to a micro USB (Universal Serial Bus) connector of which the molding holes formed during manufacturing are covered by insulative members for preventing shorting.

2. Description of Related Art

China Utility Model No. 201904481, issued on Jul. 20, 2011, discloses a micro USB connector including an insulative housing having a base portion and a tongue portion extending from the base portion, a plurality of contacts confined by a plurality of molds and insert molded with the insulative housing, a stiffener having a pair of side portions attached to the tongue portion, and a shell shielding the insulative housing. The tongue portion defines a plurality of channels on a lower surface thereof for receiving the contacts and a plurality of molding holes on an upper surface thereof for accommodating the molds.

U.S. Patent Application Publication No. 2014/0065889, published on Mar. 6, 2014, discloses a micro USB connector including an insulative housing having a base portion and a tongue portion, and a plurality of terminals. The tongue portion has a plurality of ribs formed on a lower surface thereof and a plurality of passageways alternating with the ribs. Each rib has a molding hole opened downwardly for accommodating a mold.

U.S. Pat. No. 8,864,526, issued on Oct. 21, 2014, discloses a micro USB connector including an insulative housing having a base portion and a tongue portion, and a plurality of terminals. A lower surface of the tongue portion comprises a plurality of terminal recesses receiving the terminals and a plurality of ribs each defining a cutout for accommodating a mold. An upper surface of the tongue portion defines a plurality of molding holes for accommodating molds. The micro USB connector further comprises a cover rib covering rear portions of the terminal recesses to cover lower surfaces of the terminals in order to minimize plating of the terminals.

The molding holes are exposed outwardly when the molds are removed. When conductive particles fall into the molding holes, it is prone to fire break-out due to shorting.

An improved micro USB connector is desired.

### SUMMARY OF THE INVENTION

Accordingly, an object of the present invention is to provide an electrical connector having molding holes covered by insulative members for preventing shorting.

In order to achieve the object set forth, an electrical connector includes an insulative housing, a number of terminals, a stiffener, and a pair of insulative members. The insulative housing includes a tongue portion defining a number of first passageways and two molding holes for accommodating a number of molds. The stiffener is insert molded with the insulative housing and defines two openings communicating with the molding holes. The insulative members cover the openings for sealing the molding holes after removal of the molds.

The first terminals and the stiffener could be confined at predetermined positions precisely by the molds. The molding holes are sealed by the insulative members to prevent conductive particles from falling into the molding holes to cause fire breakout.

Other objects, advantages and novel features of the invention will become more apparent from the following detailed description when taken in conjunction with the accompanying drawings.

### BRIEF DESCRIPTION OF THE DRAWINGS

FIG. 1 is an assembled perspective view showing an electrical connector in accordance with the present invention;

FIG. 2 is a partly exploded perspective view showing the electrical connector shown in FIG. 1, with a shell separated from an insulative housing together with terminals;

FIG. 3 is another partly exploded view similar to FIG. 2, taken from another aspect;

FIG. 4 is a partly exploded view showing the electrical connector shown in FIG. 2, with the shell, a first insulative member, and a second insulative member separated from the insulative housing;

FIG. 5 is an exploded view showing the electrical connector shown in FIG. 1; and

FIG. 6 is another exploded view similar to FIG. 5, taken from another aspect.

### DETAILED DESCRIPTION OF THE PREFERRED EMBODIMENT

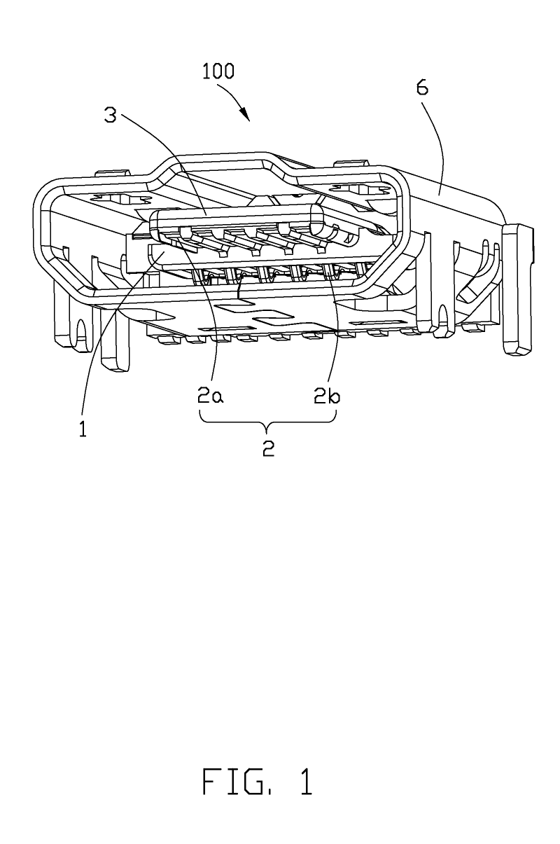

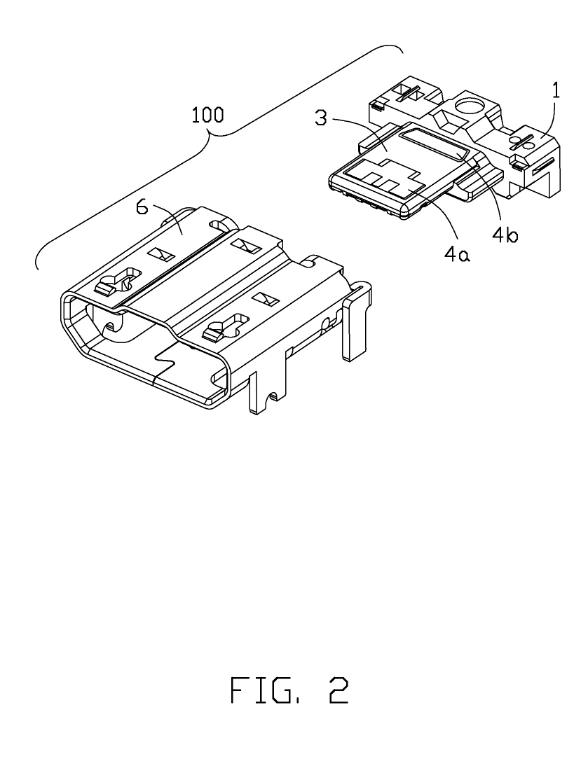

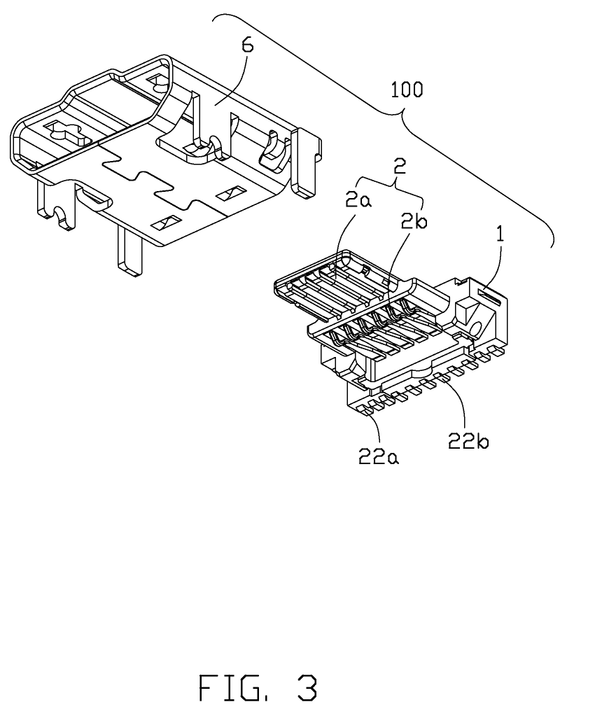

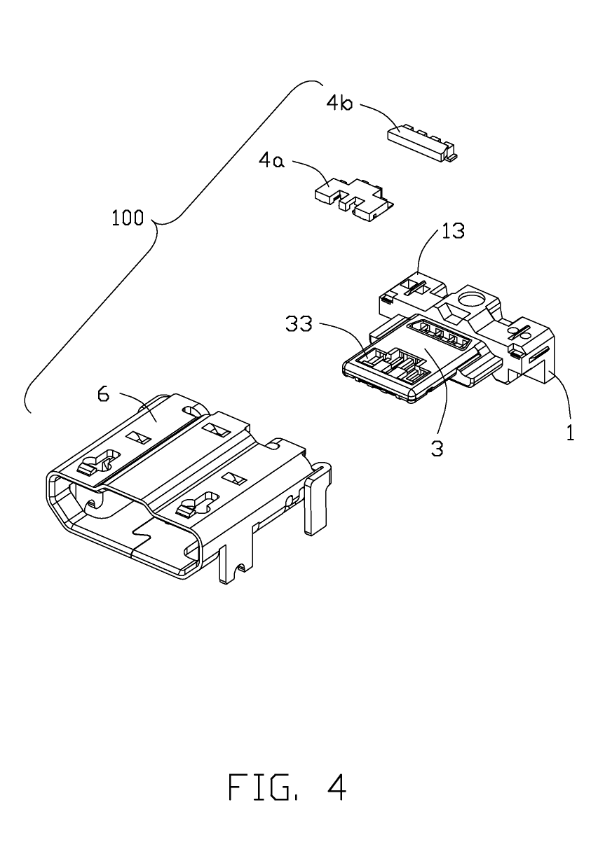

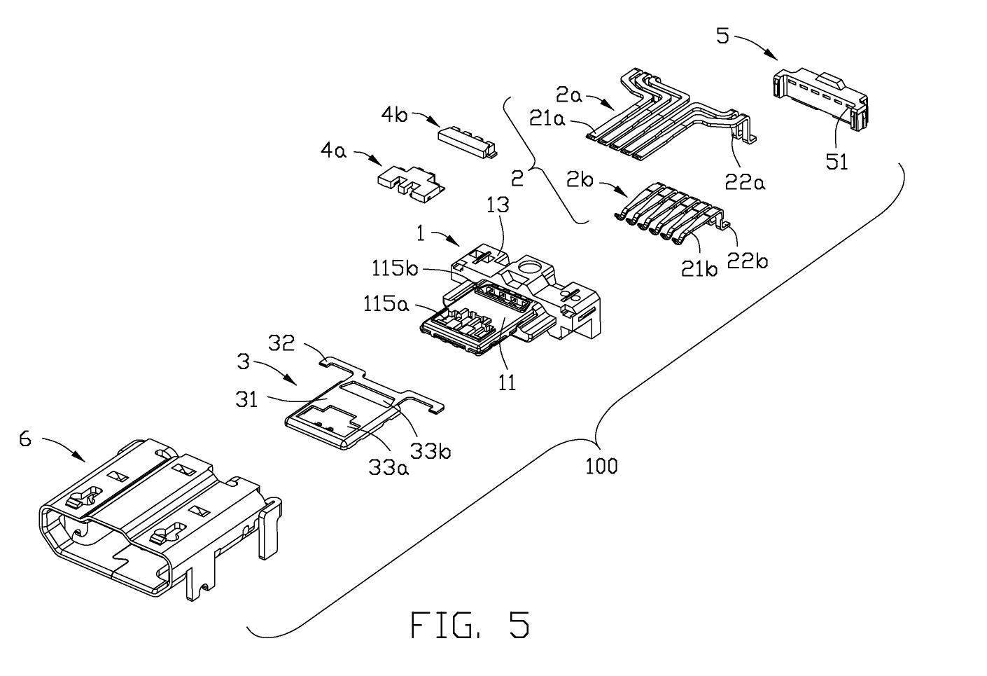

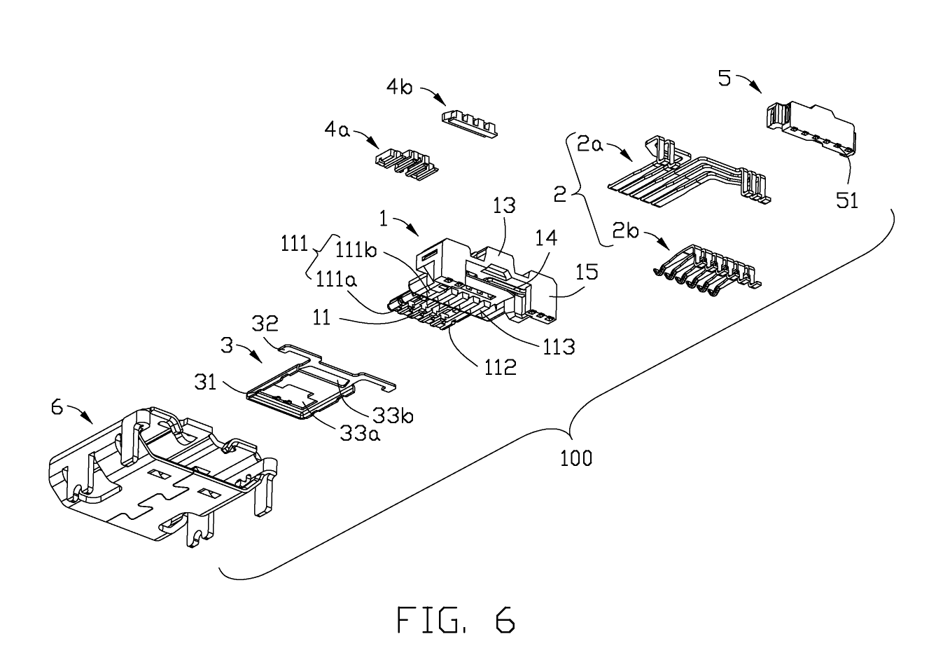

Reference will now be made in detail to the preferred embodiment of the present invention. Referring to FIGS. 1-6, an electrical connector 100 comprises an insulative housing 1, a plurality of terminals 2 secured to the insulative housing 1, a stiffener 3 attached to the insulative housing 1, a first insulative member 4a, a second insulative member 4b, a positioning structure 5 and a shell 6.

An insulative housing 1 includes a base portion 13, a tongue portion 11 extending forwardly from the base portion 13 and defining a plurality of passageways 111, a pair of supporting portions 15 disposed at opposite sides of a rear portion of the base portion 13, and a mounting hole 14 defined between the pair of supporting portions 15. The tongue portion 11 includes a front portion 112 and a rear portion 113. The passageways 111 include a plurality of first passageways 111a extending from the front portion 112 to the supporting portions 15, and a plurality of second passageways 111b extending along the rear portion 113.

The terminals 2 include a plurality of first terminals 2a secured in the first passageways 111a and a plurality of second terminals 2b secured in the second passageways 111b. Each first terminal 2a is formed with a flat first contact portion 21a and a first soldering portion 22a. Each second terminal 2b is formed with a curved second contact portion 21b and a second soldering portion 22b.

The stiffener 3 comprises a body portion 31 attached to the upper portion of the tongue portion 11 and a pair of beams 32 extending laterally from the body portion 31. The body portion 31 defines a first opening 33a communicating with a first molding hole 115a and a second opening 33b rearward the first opening 33a and communicating with a second molding hole 115b.

The first insulative member 4a and the second insulative member 4b are made from resin, rubber or other insulative material. The first insulative member 4a cover the first opening 33a for sealing the first molding hole 115a. The second insulative member 4b covers the second opening 33b for sealing the second molding hole 115b.

The positioning structure 5 defines a plurality of grooves 51 communicating with the second passageways 111b.

In assembling of the electrical connector 100, in a first step, punching the plurality of terminals 2 and the stiffener 3 from a metal plate.

In a second step, confining the plurality of terminals 2 in certain positions by a plurality of molds. Insert molding the first terminals 2a and stiffener 3 with the insulative housing 1. The first contact portions 21a are received in the first passageways 111a. The first soldering portions 22a extend outwardly from the first passageways 111a. The stiffener 3 is attached to a front face of the tongue portion 11.

In a third step, removing the molds to define the plurality of first openings 33a and the second openings 33b in the stiffener 3 and the first and second molding holes 115a, 115b in the tongue portion 11. The first and second molding holes 115a, 115b partially communicate with the first passageways 111a. The first molding holes 115a communicate with the first openings 33a and the second molding holes 115b communicate with the second openings 33b. Pruning redundant material strip of the metal plate.

In a fourth step, covering, optimally insert molding, the first insulative member 4a onto the stiffener 3 to cover the first opening 33a for sealing the first molding hole 111a, and covering, optimally insert molding, the second insulative member 4b onto the stiffener 3 to cover the second opening 33b for sealing the second molding hole 111b. The second terminals 2b are insert molded with the positioning structure 5. The second terminals 2b together with the positioning structure 5 is mounted to the insulative housing 1, with the second contact portions 21b received in the second passageways 111b and the positioning structure 5 received in the mounting hole 14 of the insulative housing 1. Finally enclosing the subassembly into the shell 6.

Optionally, the stiffener 3 could be mounted onto the insulative housing 1 after the first terminals 2a insert molded with the insulative housing 1.

The first terminals 2a and the stiffener 3 could be confined at predetermined positions precisely by the molds. The first and second molding holes 115a, 115b are sealed by the insulative members 4a, 4b to prevent conductive particles from falling into the first and second molding holes 115a, 115b to cause fire breakout.

It is to be understood, however, that even though numerous characteristics and advantages of the present invention have been set forth in the foregoing description, together with details of the structure and function of the invention, and changes may be made in detail, especially in matters of shape, size, and arrangement of parts within the principles of the invention to the full extent indicated by the broad general meaning of the terms in which the appended claims are expressed.

What is claimed is:

1. An electrical connector comprising:
an insulative housing including a base portion and a tongue portion extending forwardly from the base portion, said tongue portion defining a plurality of first passageways at a lower surface thereof and at least one molding hole exposed at an upper surface thereof and communicating with said first passageways for accommodating a plurality of molds;
a plurality of terminals including first terminals insert molded with the insulative housing and secured in the first passageways, each first terminal having a contact portion exposed to the first passageway;
a stiffener insert molded with the insulative housing, the stiffener being attached to the tongue portion and defining at least one opening communicating with said at least one molding hole; and
at least one insulative member covering said at least one opening for sealing said at least one molding hole after removal of the molds.

2. The electrical connector as claimed in claim 1, wherein said at least one insulative member is insert molded with aid at least one opening for sealing the molding hole.

3. The electrical connector as claimed in claim 2, said terminals further include a plurality of second terminals insert molded with a positioning structure and mounted onto the insulative housing.

4. A method of manufacturing an electrical connector, comprising the steps of:
punching a plurality of terminals from a metal plate;
positioning said plurality of immovable terminals in predetermined positions by a plurality of molds;
molding the terminals with an insulative housing via a first insert-molding process, said insulative housing including a base portion and a tongue portion extending forwardly the base portion with two opposite surfaces thereon, said tongue portion forming a plurality of passageways to receive the corresponding terminals therein and to expose said terminals on one surface of the tongue portion;
removing the molds from the joined housing and terminals to define in the housing a plurality of molding holes which communicate with the corresponding passageways, respectively; and
applying insulative material within the molding holes so as to isolate the terminals from an exterior.

5. The method as claimed in claim 4, wherein the step of applying insulative material within the molding holes is a second insert-molding process.

6. The method as claimed in claim 5, further including steps of providing a stiffener stamped from another metal plate, disposing said stiffener in a position spaced from said terminals with a distance in a vertical direction so as to have said stiffener integrally molded with the tongue portion during said first insert-molding process simultaneously and exposed upon the other surface of the tongue portion.

7. The method as claimed in claim 6, wherein said stiffener includes an opening set aligned with the mounting holes in the vertical direction for said first insert-molding process.

8. The method as claimed in claim 7, wherein said opening set is filled with the insulative material in the second insert-molding process.

9. The method as claimed in claim 5, further comprising a step of insert molding a plurality of deflectable terminals with a positioning structure and mounting said deflectable terminals onto the insulative housing after the second insert-molding process.

10. The method as claimed in claim 9, further including a step of assembling a metallic shell upon the housing, wherein said shell forms a receiving cavity in which said tongue portion extends.

11. An electrical connector comprising:
an insulative housing including a base portion and a tongue portion extending forwardly therefrom in a front-to-back direction;
a plurality of immovable terminals embedded within the housing via an insert-molding process, the tongue portion defining a plurality of passageways arranged with one another in a transverse direction perpendicular to said front-to-back direction to receive said immovable terminals therein, and a plurality of molding holes communicating with said passageways in a vertical direction perpendicular to both said front-to-back direction and said transverse direction for receiving corresponding molds during said insert-molding process; and
an insulative block including a plurality of parts filled within the corresponding mounting holes after the insert-molding process to preventing shorting; wherein
both said immoveable terminals and said insulative block are exposed to an exterior in the vertical direction.

12. The electrical connector as claimed in claim 11, wherein said insulative block is formed by another molding process.

13. The electrical connector as claimed in claim 12, wherein the tongue portion defines opposite surfaces in the vertical direction, and the immoveable terminals are exposed upon one surface while the insulative block is exposed upon the other surface.

14. The electrical connector as claimed in claim 11, further including a metallic stiffener embedded within the tongue portion, said stiffener includes an opening set for molding consideration.

15. The electrical connector as claimed in claim 14, wherein said stiffener is exposed upon one surface of the mating tongue in the vertical direction.

16. The electrical connector as claimed in claim 11, wherein further including a metallic shell enclosing the housing, wherein said shell defines a receiving cavity in which the tongue portion extends forwardly.

17. The electrical connector as claimed in claim 11, further including a plurality of deflectable terminals integrally molded within a positioning structure which is attached to the housing, wherein said deflectable terminals are essentially located behind the immoveable terminals in the front-to-back direction.
